(19) United States
(12) Patent Application Publication
(10) Pub. No.: US 2025/0375880 A1
(43) Pub. Date: Dec. 11, 2025

(54) OPERATION CONTROL METHOD, OPERATION CONTROL DEVICE, AND STORAGE MEDIUM

(71) Applicant: HONDA MOTOR CO., LTD., Tokyo (JP)

(72) Inventors: Yohei Kitahara, Wako-shi (JP); Tadaaki Hasegawa, Wako-shi (JP)

(21) Appl. No.: 19/208,833

(22) Filed: May 15, 2025

(30) Foreign Application Priority Data
Jun. 11, 2024 (JP) 2024-094359

(51) Int. Cl. B25J 9/16; B25J 13/08; B25J 15/00

(52) U.S. Cl. CPC B25J 9/1633; B25J 9/1612; B25J 9/1689; B25J 13/082; B25J 15/0009

(57) ABSTRACT

An operation control method includes: a step of transmitting action force information when an operator handles an object to an end effector; a calculation step of calculating a target action force for grasping the object using the end effector from an acquired state of the operator and the acquired action force information; a detection step of detecting a contact force at contact points at which the contact portions are in contact with the object; and a control step of controlling an operation of a driver of the end effector such that an action force acting on the object from each contact element matches the target action force.

### CROSS-REFERENCE TO RELATED APPLICATION

Priority is claimed on Japanese Patent Application No. 2024-094359, filed Jun. 11, 2024, the content of which is incorporated herein by reference.

### BACKGROUND

### Field of the Invention

The present invention relates to an operation control method, an operation control device, and a storage medium.

### Description of Related Art

When a person remotely controls a robot to handle an object, it has been proposed that information such as joint angles of fingers of an operator acquired from sensors of a data glove or the like is applied to the robot (for example, Japanese Unexamined Patent Application, First Publication No. 2005-14166).

### SUMMARY

However, in the related art, a robot may not appropriately handle an object due to an error of the sensors, a difference in length of a finger between the robot and a person, a non-force-based instruction, or the like. Even when a robot recognizes an object and the robot automatically performs handling of the object to a certain extent, it is not easy to accurately recognize the object due to occlusion or the like in the related art. That is, in the related art, it is difficult to handle an object without using object information.

The present invention was made in consideration of the aforementioned problems, and an objective thereof is to provide an operation control method, an operation control device, and a storage medium that can handle an object without using object information.

(1) In order to achieve the objective, according to an aspect of the present invention, there is provided an operation control method for an end effector including a plurality of contact portions which are able to handle an object, the operation control method including: a step of transmitting action force information when an operator handles the object to the end effector; a calculation step of calculating a target action force for grasping the object using the end effector from an acquired state of the operator and the acquired action force information; a detection step of detecting a contact force at contact points at which the contact portions are in contact with the object; and a control step of controlling an operation of a driver of the end effector such that an action force acting on the object from each contact element matches the target action force, wherein the calculation step includes setting a center coordinate system with a center coordinate of a contact point instruction value for the end effector calculated from the action force information as an origin, calculating contact point positions of the end effector in the center coordinate system, converting coordinates of the contact point positions according to a change of the center coordinate system calculated from the updated action force information, and using an instruction value based on the coordinate-converted contact point positions as a corrected instruction value.

(2) In the operation control method according to the aspect of (1), the calculation step may include: calculating a contact tangent component at each contact point of a difference between a shift of the action force information and a shift of the contact point positions due to the coordinate conversion; and adding the contact tangent component to the coordinate-converted contact point positions to use the result as the corrected instruction value.

(3) In the operation control method according to the aspect of (2), the contact point positions may be updated using the contact tangent component and the coordinates of the contact point positions may be converted according to a change of the center coordinate system calculated from next updated action force information.

(4) In the operation control method according to the aspect of (1), the control step may include determining whether the operators is giving an instruction to separate the end effector including a plurality of fingers from the object after having brought the end effector into contact with the object or an instruction to move the object while grasping the object by determining whether a finger of the operator is located outside of a surface of the object or a finger of the operator has infiltrated into the object on the basis of a relative vector and a normal direction in the center coordinate system of each of the plurality of fingers.

(5) In the operation control method according to the aspect of (1), the control step may include: setting a temporary contact point position in a predetermined range from a surface of the object; and determining whether the operator is giving an instruction to separate the end effector away from the object after having brought the end effector into contact with the object or whether the operator is attempting to separate the end effector away from the object and to stop separating of the end effector away from the object before the end effector is separated away from the object on the basis of the temporary contact point position and an instruction value given by the operator.

(6) In the operation control method according to the aspect of (1), the end effector may include a plurality of fingers, the center coordinate system may be set with one of the plurality of fingers as a reference, an axial direction passing through the center coordinate from the reference finger may be set as a first axial direction, a second axial direction may be set in a plane including the first axial direction, and a third axial direction may be set with respect to the plane.

(7) In the operation control method according to the aspect of (1), the action force information may be a joint angle of a finger of the operator, and the center coordinate system may be a contact point instruction value for the end effector calculated in a state in which a joint angle of the end effector matches the joint angle of the operator.

(8) In order to achieve the objective, according to another aspect of the present invention, there is provided an operation control device for an end effector including a plurality of contact portions which are able to handle an object, the operation control device including: an output configured to transmit action force information when an operator handles the object to the end effector; a calculator configured to calculate a target action force for grasping the object using the end effector from an acquired state of the operator and the acquired action force information; a detector configured to detect a contact force at contact points at which the contact portions are in contact with the object; and a controller configured to control an operation of a driver of the end effector such that an action force acting on the object from each contact element matches the target action force, wherein the calculator performs setting a center coordinate system with a center coordinate of a contact point instruction value for the end effector calculated from the action force information as an origin, calculating contact point positions of the end effector in the center coordinate system, converting coordinates of the contact point positions according to a change of the center coordinate system calculated from the updated action force information, and using an instruction value based on the coordinate-converted contact point positions as a corrected instruction value.

(9) In order to achieve the objective, according to another aspect of the present invention, there is provided a non-transitory computer-readable storage medium storing a program, the program causing a computer of an operation control device for an end effector including a plurality of contact portions which are able to handle an object to perform: transmitting action force information when an operator handles the object to the end effector; calculating a target action force for grasping the object using the end effector from an acquired state of the operator and the acquired action force information; detecting a contact force at contact points at which the contact portions are in contact with the object; and controlling an operation of a driver of the end effector such that an action force acting on the object from each contact element matches the target action force, wherein the calculating of a target action force includes setting a center coordinate system with a center coordinate of a contact point instruction value for the end effector calculated from the action force information as an origin, calculating contact point positions of the end effector in the center coordinate system, converting coordinates of the contact point positions according to a change of the center coordinate system calculated from the updated action force information, and using an instruction value based on the coordinate-converted contact point positions as a corrected instruction value.

According to the aspects of (1) to (9), it is possible to handle an object without using object information.

### BRIEF DESCRIPTION OF THE DRAWINGS

FIG. 1 is a diagram illustrating an example of a configuration of an operation control system according to an embodiment.

FIG. 2 is a diagram illustrating an example of an end effector including multiple fingers.

FIG. 3 is a diagram illustrating a center coordinate according to the embodiment.

FIG. 4 is a diagram illustrating an example of constraint.

FIG. 5 is a flowchart illustrating a remote control process according to the embodiment.

FIG. 6 is a diagram illustrating a first example of a process of generating a corrected instruction value.

FIG. 7 is a diagram illustrating a second example of the process of generating a corrected instruction value.

FIG. 8 is a diagram illustrating an operation when an operator's finger is far away from an object.

FIG. 9 is a diagram illustrating division of an operation for separating a finger or an operation for moving an object.

FIG. 10 is a diagram illustrating a control method when an object is grasped with three fingers and then one finger is separated from the object.

FIG. 11 is a flowchart illustrating a determination process of finger separate or the like according to the embodiment.

FIG. 12 is a flowchart illustrating a determination process of re-contact or the like according to the embodiment.

### DETAILED DESCRIPTION OF THE INVENTION

Hereinafter, an operation control method, an operation control device, and a storage medium according to an embodiment of the present invention will be described with reference to the accompanying drawings. In the drawings used for the following description, scales of constituent members are appropriately changed in order to allow the constituent members to be illustrated in recognizable sizes.

In all the drawings used to describe embodiments, constituent members having the same functions will be referred to by the same reference signs, and repeated description thereof will be omitted.

“On the basis of XX” mentioned in this specification means “on the basis of at least XX” and includes “on the basis of another element in addition to XX.” “On the basis of XX” is not limited to direct use of XX and includes use of results obtained by performing calculation or processing on XX. “XX” is an arbitrary factor (for example, arbitrary information).

### [Outline]

In an embodiment, for example, an object is handled by a robot at the time of remote control. In the present embodiment, until a hand of an end effector comes into contact with an object, an operator (which may be referred to as a handler) operates an arm or the hand on the basis of an image captured by a camera attached to the robot or the like. In the present embodiment, thereafter, grasp support is performed by calculating a force balance on the basis of a designated magnitude of a grasping force and contact sensor information on the hand instead of object information and controlling finger forces such that the object is handled. Handling of an object includes, for example, an operation for changing a posture and a rotation direction of the object, an operation of causing a finger to move (slide) on the object, and an operation for separating a finger after the finger has been brought into contact with the object. Support means that an instruction value instructed when the operator performs remote control is corrected by an operation control device side and the end effector is appropriately operated to handle the object.

### [Example of Configuration of Operation Control System]

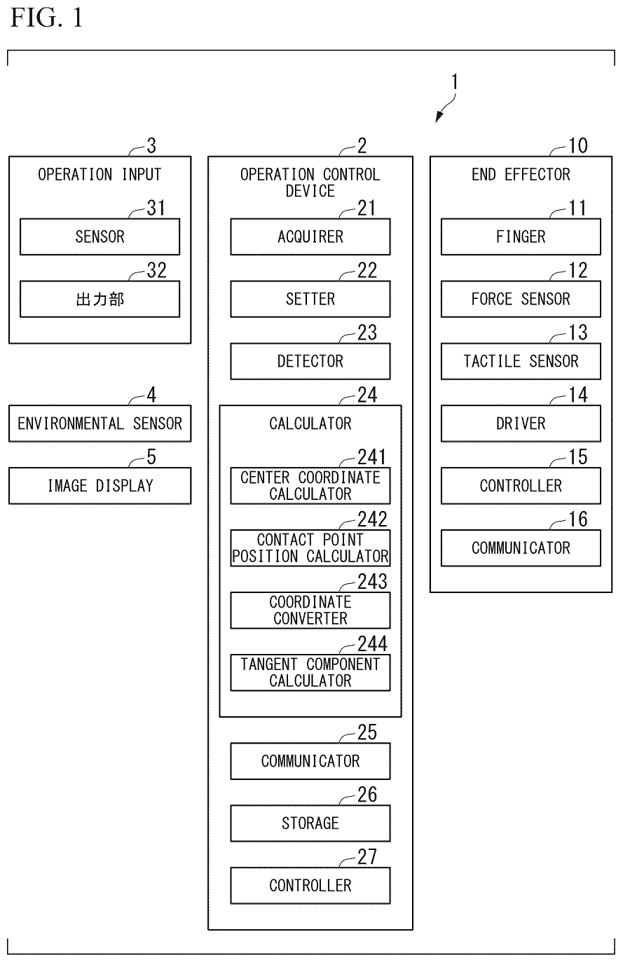

FIG. 1 is a diagram illustrating an example of a configuration of the operation control system according to the present embodiment. As illustrated in FIG. 1, the operation control system 1 includes, for example, an end effector 10 (a robot), an operation control device 2 (a remote control device), an operation input 3, an environmental sensor 4, and an image display 5.

The end effector 10 includes, for example, a finger 11, a force sensor 12, a tactile sensor 13, a driver 14, a controller 15, and a communicator 16. The end effector 10 may include, for example, an imager on the back of a hand or the like.

The operation control device 2 includes, for example, an acquirer 21, a setter 22, a detector 23, a calculator 24, a communicator 25, a storage 26, and a controller 27. The calculator 24 includes, for example, a center coordinate calculator 241, a contact point position calculator 242, a coordinate converter 243, and a tangent component calculator 244.

The operation input 3 is, for example, a data glove and is worn on a hand of an operator. The operation input 3 detects an operation result from the operator and outputs the operation result to the operation control device 2. The data glove includes, for example, a plurality of sensors 31 and an output 32.

The sensors 31 include, for example, a bending sensor, a valgus sensor, and a sensor measuring palm bending (palmar arch), wrist bending, or eversion. The sensors 31 detect motion of a user's hand or fingers as joint angle data. Detection of a joint angle may be performed by the operation input 3 or may be performed by the operation control device.

The environmental sensor 4 is, for example, RGB (red, green, blue) D imaging device that can also measure depth information D. The environmental sensor 4 is installed, for example, in a range in which an object or the end effect 10 can be imaged. The number of environmental sensors 4 may be two or more.

The image display 5 is, for example, a head mount display (HMD) or an image display device. The image display 5 is installed on an operator side. The operation control device 2 and the image display 5 are connected in a wired manner or a wireless manner. When the image display 5 is an HMD, the HMD may detect a gaze of the operator. Then, the HMD may output the detected gaze information to the operation control device 2.

The end effector 10 is, for example, a multi-finger hand including three fingers 11. The end effector 10 is connected to an arm which is not illustrated.

The force sensor 12 is, for example, a pressure sensor or a 6-axis force sensor (6 AF sensor) that can measure a magnitude a force or a torque acting in a plurality of directions in real time.

The tactile sensor 13 is, for example, a tactile sensor that detects information felt by a tactile sense provided on the back of a human hand and converts the information to an electrical signal. Detection of a contact position between an object and the finger 11 may be performed by a known contact position detection algorithm using a detection value detected by 6-axis sensor.

The driver 14 includes, for example, a drive circuit and an actuator. The driver 14 drives joints of the end effector 10 under the control of the controller 15.

The controller 15 transmits detection values detected by the sensors to the operation control device 2 via the communicator 16. The controller 15 acquires control information transmitted from the operation control device 2 via the communicator 16.

The communicator 16 transmits information output from the controller 15 to the operation control device 2. The communicator 16 receives control information transmitted from the operation control device 2 and outputs the received control information to the controller 15.

The operation control device 2 controls the end effector 10. The operation control device 2 and the operation input 3 are connected in a wired manner or a wireless manner. The operation control device 2 and the environmental sensor 4 are connected in a wired manner or a wireless manner. The operation control device 2 may be provided in a robot including the end effector 10 or the like.

The acquirer 21 acquires an operation result of the operator (a state of the operator) from the operation input 3. The acquirer 21 acquires a detection value from the force sensor 12 as a state quantity (such as a joint angle of a hand). The acquirer 21 acquires an image (depth information included therein) captured by the environmental sensor 4, performs image processing on information included in the acquired image, and acquires a state quantity of an operation target object (such as a position and a posture of a target operation).

The setter 22 sets a target action force with which an object is grasped by the end effector 10. The setter 22 sends action force information when the operator handles the object to the end effector 10. The setter 22 calculates the target action force from the state of the operator acquired by the acquirer 21 and the action force information. That is, the target action force which is a target of a balance between forces is calculated, for example, on the basis of a grasping force instructed by the operator (for example, information instructed to the data glove) and operator information (a size of a hand, a gaze, or various types of other information of the operator)

The detector 23 detects a contact point with an object and a contact force at a contact point with an object using the information acquired by the acquirer 21.

The calculator 24 calculates a target action force with which an object is grasped by the end effector 10 from the state of the operator from the sensors 31 and the action force information.

The center coordinate calculator 241 calculates a center coordinate system with the center coordinate of a contact point instruction value for the end effector 10 calculated from the action force information as an origin. In the following description, a coordinate system with the center coordinate as an origin is referred to as a center coordinate system. In the center coordinate system, for example, an x-axis direction, a y-axis direction, and a z-axis direction are set with respect to a first finger (for example, a thumb). The center coordinate is a coordinate in the world coordinate system. The center coordinate changes according to a fingertip position because the fingertip position (the contact point position) changes according to an instruction from the operator.

The contact point position calculator 242 calculates a contact point position pi (where i is an integer of 1 or greater) of the end effector 10 with an object in the center coordinate system. Here, p1 is, for example, a fingertip position of a thumb, p2 is, for example, a fingertip position of an index finger, and p3 is, for example, a fingertip position of a ring finger. At the time of start of grasping, the contact point position calculator 242 stores a fingertip position pi (time t=1) of the robot in the center coordinate system in the storage 26. After grasping has started, for example, at time t=2, the contact point position calculator 242 stores a newly contacted fingertip position as the fingertip position pi of the robot in the center coordinate in the storage 26. For example, at time t=2, the contact point position calculator 242 calculates and updates the fingertip position in contact at that time from a final instruction value and stores the calculated and updated fingertip position as an updated fingertip position pi in the storage 26. The fingertip position is expressed as a position with the center coordinate in the world coordinate system as an origin.

The coordinate converter 243 converts the coordinate of the contact point position pi stored in the storage 26 according to the calculated change of the center coordinate from the action force information at the time of updating. In other words, the coordinate converter 243 converts the fingertip position pi stored in the storage 26 at the time of grasping to the fingertip position after the center coordinate has changed according to the change of the center coordinate.

The tangent component calculator 244 calculates a contact tangent component at a contact point of a difference between a shift of the action force information before and after the updating and a shift of the contact point position pi due to the coordinate conversion.

The communicator 25 transmits and receives information to and from the end effector 10.

The storage 26 stores, for example, programs, mathematical expressions, and threshold values used by the operation control device 2. The storage 26 stores positions at which the sensors (the force sensor 12 and the tactile sensor 13) are attached. The storage 26 stores a relationship between a size and a mass of an object in the form of a table or a mathematical expression.

The controller 27 generates an instruction value on the basis of the operation result of the operator. The controller 27 outputs the generated instruction value to the end effector 10 via the communicator 25 and brings a contact portion of the end effector 10 into contact with an object. The contact portion is, for example, the finger 11, a fingertip of the finger 11, or the back of the finger 11. After the contact, the controller 27 generates a corrected instruction value by adding the contact tangent component to the contact point position pi subjected to the coordinate conversion. The controller 27 determines whether the operation result is an operation for separating the finger 11 from the object after the finger 11 of the end effector 10 has been brought into contact with the object or an operation for moving the object with the object grasped and corrects the instruction value. The controller 27 outputs the corrected instruction value to the end effector 10 via the communicator 25. The controller 27 provides an image captured by the environmental sensor 4 to the image display 5 via the communicator 25.

### [End Effector]

An example of an end effector 10 including multiple fingers will be described below.

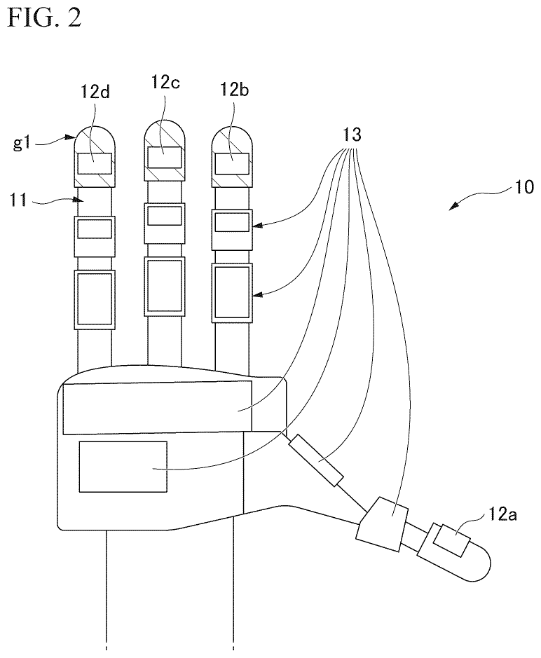

FIG. 2 is a diagram illustrating an example of an end effector including multiple fingers. In the example illustrated in FIG. 2, the number of fingers 11 is four, but the number of fingers 11 is not limited thereto and may be, for example, two, three, or five or more.

For example, force sensors 12 (12a, 12b, 12c, and 12d) which are 6-axis sensors are attached to fingertips of the fingers 11.

A tactile sensor 13 is attached to the back of each finger or the palm.

As indicated by reference sign g1, for example, rubber is attached to the fingertips of the fingers 11.

The rubber may be an object or a protrusion causing friction with respect to an object to a certain extent. In the following description, a functional part including the fingers 11 and the palm in the end effector 10 is also referred to as a “hand.”

### [Center Coordinate, Center Coordinate System]

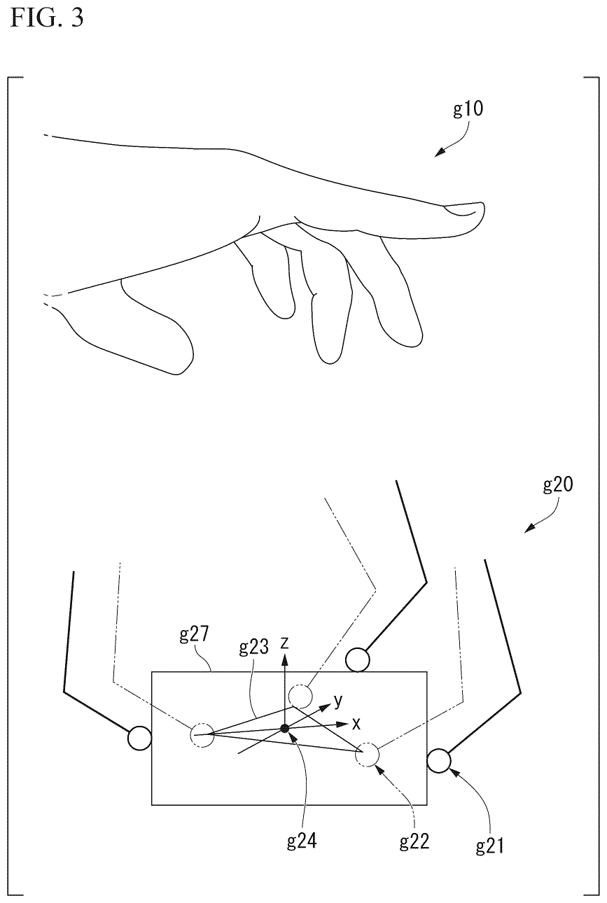

FIG. 3 is a diagram illustrating a center coordinate according to the present embodiment.

An image g10 is an image of a hand of an operator at the time of remote control. In the image g10, the data glove is not illustrated. Operation details are, for example, grasping an object or moving an object with the object grasped.

An image g20 illustrates contact positions between fingertips and an object g27 when the fingers 11 of the robot grasp the object g27 through remote control and positions of the fingertips based on an instruction value. Solid circles g21 indicate fingertip positions of the robot at the time of grasping. Chained circles g22 indicate fingertip positions based on a fingertip instruction value of the robot calculated by matching joint angles of the robot with joint angles of the operator measured using the data glove or the like.

At the time of remote control, like the image g20, a fingertip position based on an instruction from the operator may be infiltrated into the object g27. In the present embodiment, the status of the image g20 is permitted. In the present embodiment, the center of the fingertip positions based on the instruction value after the fingertips of the robot has contacted is referred to as a “center coordinate g24.” The center coordinate may also be a virtual object posture instruction value. In the following example, the center coordinate is calculated from action force information (such as a contact point position instruction value) of the operator, but the present invention is not limited thereto. For example, the object posture instruction value of the operator may be given in any form (another device may be simultaneously operated with the hand wearing the data glove or an interface of something) or may be input independently from the action force information. The center coordinate g24 may be, for example, a load center or the center of gravity of a triangle g23 formed by three fingertip positions. In the present embodiment, an x-axis direction, a y-axis direction, and a z-axis direction are set with respect to the center coordinate, for example, with a predetermined finger (for example, a thumb) as a reference. The x-axis direction is, for example, a direction toward the center coordinate from the thumb. The y-axis direction is, for example, a depth direction. The z-axis direction is, for example, a thickness direction of the object. The finger serving as the reference is not limited to the thumb, but may be another finger. In this way, the center coordinate system sets one of the plurality of fingers 11 as a reference, an axial direction passing through the center coordinate from the reference finger is set as a first axial direction (the x-axis direction), a second axial direction (the y-axis direction) is set in a plane including the first axial direction, and a third axial direction (the z-axis direction) is set with respect to the plane.

In the present embodiment, when there is an extra force in the center coordinate system after grasping, a corrected instruction value is generated by adding a constraint to the extra force and controls the end effector 10.

A force instruction changes from time to time according to a remote control instruction. For example, the technique described in Japanese Unexamined Patent Application, First Publication No. 2023-046654 is used to generate such an instruction value and to balance forces. In this technique, the target action force is a scalar value which is a value based on an operation of the operator. The weight of the object, a grasping force estimated on the basis thereof, and the like are also calculated, for example, using the technique described in Japanese Unexamined Patent Application, First Publication No. 2023-046654. Accordingly, information used to operate the object is only the target action force and contact information between the object and the fingers of the end effector 10.

In this control, when the instruction value has infiltrated into the object, for example, an extra force may be generated or the grasping force may be excessively strong, and thus appropriate control may not be possible. In this case, the grasping becomes unstable. Accordingly, in the present embodiment, the center coordinate based on the fingertip positions infiltrated into the object is used. In the present embodiment, a component infiltrated into the object is subtracted from the movement of the fingers of the operator relatively seen from the movement of the center coordinate or the movement of the fingers based on a virtual instruction value based on the center coordinate, and the instruction value is corrected.

The joint angles of the fingers of the operator are detected by the sensors 31 of the operation input 3 which is worn by the operator. A grasping center position is the center (or the center of gravity) of the fingertip positions at which the fingers 11 of the end effector 10 are actually in contact with the object. On the other hand, the center position is the center (or the center of gravity of virtual fingertip positions based on an instruction value due to movement based on the joint angles of the operator. By setting the x, y, and z axes passing through the center coordinate, the posture of the object can be defined and controlled.

The controller 27 determines whether a normal component has infiltrated into the object g27 on the basis of an instruction value in a relative vector. This determination is performed after the fingers 11 has come into contact with the object.

### [Example of Constraint]

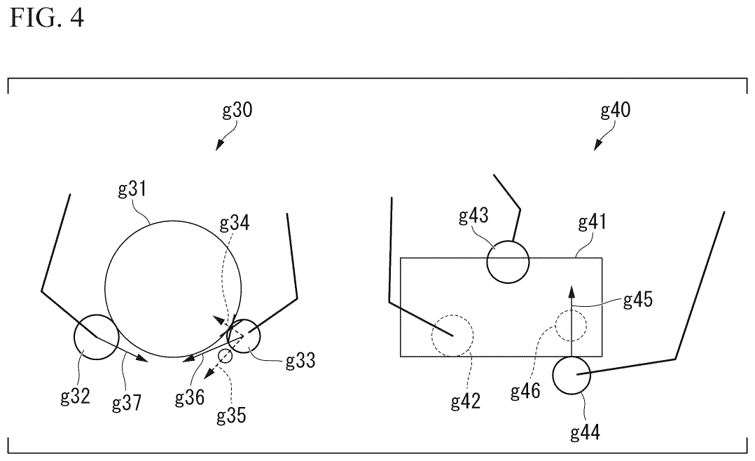

An example of constraint will be described below. FIG. 4 is a diagram illustrating an example of constraint.

An image g30 is, for example, an image when a sphere g31 is handled with two fingers (a first finger and a second finger) of the robot. Reference signs g32 and g33 indicate fingertips of the fingers. Arrows g36 and g37 indicate pre-correction instruction values for the fingertips. In the example of the image g30, the fingertip g33 of the second finger is intended to slide on the sphere g31 in a state in which the sphere g31 is grasped (for example, a grasp changing operation). In this operation, out of a tangent component g35 and a normal component g34 of the instruction value g36, it is intended to cancel the normal component g34 and to perform control using the tangent component g35.

An image g40 is, for example, an image of an operation for grasping a rectangular parallelepiped g41 with three fingers (a first finger, a second finger, and a third finger) and then moving the third finger to change the posture of the object. In the image g40, for example, it is intended to lift the object in a direction of an arrow g45. Reference signs g42, g43, and g44 indicate fingertips of the fingers. A chained circle g46 indicates a position after the fingertip has been moved. In this operation, unlike the operation of the image g30, the operation is performed using the normal component.

The normal and tangent components cannot be simply constrained as illustrated in FIG. 4.

Accordingly, in the present embodiment, operation details are determined according to movement of the fingertips of the operator in the center coordinate system, and an extra force is cancelled according to the operation.

### [Operation Sequence]

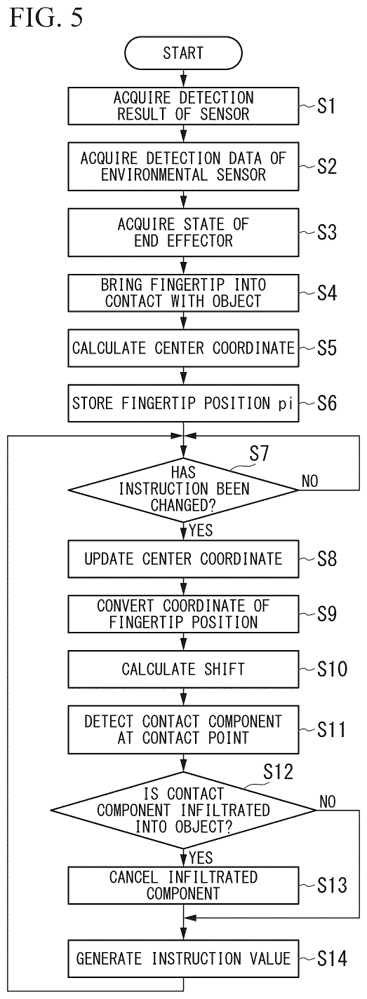

An example of an operation sequence will be described below with reference to FIGS. 5 to 7. FIG. 5 is a flowchart illustrating a process flow of remote control according to the present embodiment. Until the fingers 11 of the robot come into contact with an object, the operator controls the end effector 10 on the basis of an image captured by the environmental sensor 4 or a camera attached to the robot.
(Step S1) The acquirer 21 acquires a state of the operator detected by the sensors 31 of the operation input 3.
(Step S2) The acquirer 21 acquires detection data detected by the environmental sensor 4.
(Step S3) The acquirer 21 acquires a detected value of the force sensor 12 as a state quantity of a device (such as a joint angle of a hand). The acquirer 21 acquires an image (depth information included therein) captured by the environmental sensor 4, performs image processing on information included in the acquired image, and acquires a state quantity of an operation target object (such as a position and a posture of a target object).
(Step S4) The controller 27 brings a contact portion (for example, a fingertip or the back of a finger) of the end effector 10 into contact with the object on the basis of the state of the operator, the state quantity of the operation target object, and the state quantity of the device.
(Step S5) At the time of start of grasping (time t=1), the center coordinate calculator 241 calculates a center coordinate with the center coordinate of a contact point instruction value for the end effector 10 calculated from the action force information as an origin.
(Step S6) At the time of start of grasping, the contact point position calculator 242 calculates a contact point position pi of the end effector 10 with the object in the center coordinate system and stores a fingertip position pi of the robot in the coordinate system of the calculated center coordinate in the storage 26.
(Step S7) The controller 27 determines whether the instruction (the fingertip positions and the joint angles)) from the operator has changed. When the instruction from the operator has changed (Step S7: YES), the controller 27 causes the process flow to proceed to Step S8. When the instruction from the operator has not changed (Step S7: NO), the controller 27 repeatedly performs the process of Step S7.
(Step S8) After the instruction has changed (time t=2), the center coordinate calculator 241 calculates a center coordinate with the center coordinate of the contact point instruction value for the end effector 10 calculated from the action force information as an origin again.
(Step S9) The coordinate converter 243 converts the coordinate of the contact point position pi stored in the storage 26 according to the calculated change of the coordinate on the basis of the action force information at the updating time.
(Step S10) The coordinate converter 243 calculates a shift of the fingertip position.
(Step S11) The tangent component calculator 244 calculates a contact tangent component at a contact point of a difference between a shift in action force information before and after the updating and a shift of the contact point position pi due to the coordinate conversion.
(Step S12) The controller 27 determines whether the contact tangent component has infiltrated into the object. When the contact tangent component has infiltrated into the object (Step S12: YES), the controller 27 causes the process flow to proceed to Step S13. When the contact tangent component has not infiltrated into the object (Step S12: NO), the controller 27 causes the process flow to proceed to Step S14.
(Step S13) The controller 27 cancels the contact tangent component infiltrated into the object.
(Step S14) Subsequently to Step S13, the controller 27 generates a corrected instruction value by adding the contact tangent component to the contact point position pi subjected to coordinate conversion. Alternatively, subsequently to Step S12, the controller 27 generates an instruction value without correcting the instruction value.

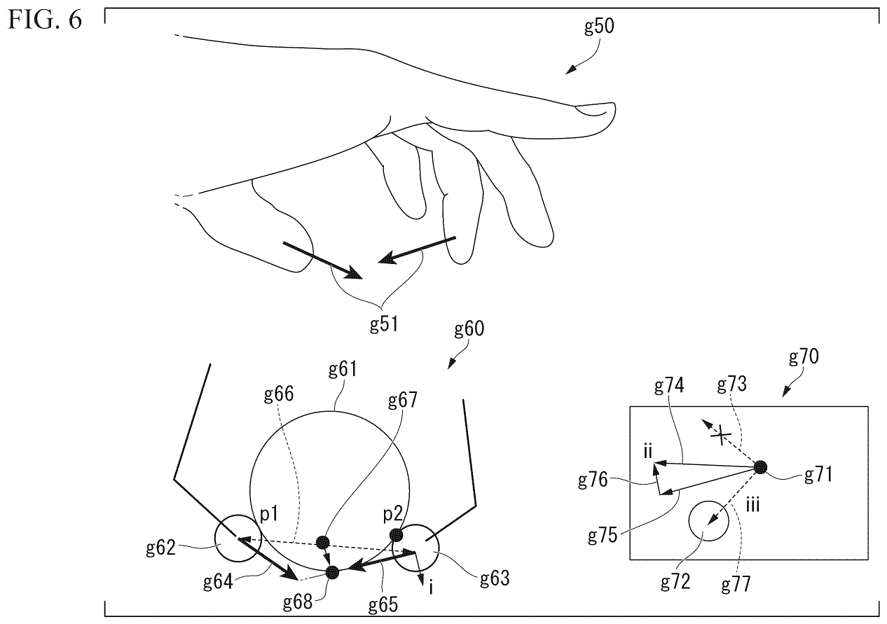

FIG. 6 is a diagram illustrating a first example of a process of generating a corrected instruction value.

An image g50 is an image of a force acting on an object based on a change of a fingertip which is remotely controlled by the operator. In the example of the image g50, the object is grasped, and fingers are caused to move (slide) on the object as indicated by arrows g51.

An image g60 is an image in which the position of the center coordinate changes in a state in which fingertips g62 and g63 of the end effector 10 are in contact with a spherical object g61. Arrows g64 and 65 are the same as vectors of the arrows g51 in the image g50 and are forces in the tangential directions. Fingertip positions are p1 and p2. A chained line g66 is a line connecting the fingertip g62 and the fingertip g63. A point g67 is a pre-change center coordinate and is, for example, a midpoint of the chained line g66. An arrow i indicates a shift of the fingertip for operating the object (a temporary instruction value based on an instruction of the operator). A point g68 is a post-change center coordinate.

An image g70 is an image illustrating a relative vector at a finger of a right hand and cancellation of a component not preferable for control. A point g71 is a fingertip position. An arrow ii (g76) is a shift. An arrow g74 is a relative vector calculated by subtracting a shift of each finger for operating an object (the arrow i in the image g60) from a finger shift of the operator. An arrow iii (g77) is a remaining component when a component infiltrated in the normal direction of the relative vector is deleted (an arrow g73).

A circle g72 indicates that the arrow g73 is deleted but the arrow g77 is left. An arrow g75 is the right arrow (=g65=finger shift of the operator) of the arrows g51.

Thereafter, the calculator 24 calculates an amount of operation of a position and a posture of the object and an amount of sliding of the finger on the object from the movement of the operator's finger. The controller 27 causes the robot to appropriately perform the operation on the basis of the information calculated by the calculator 24.

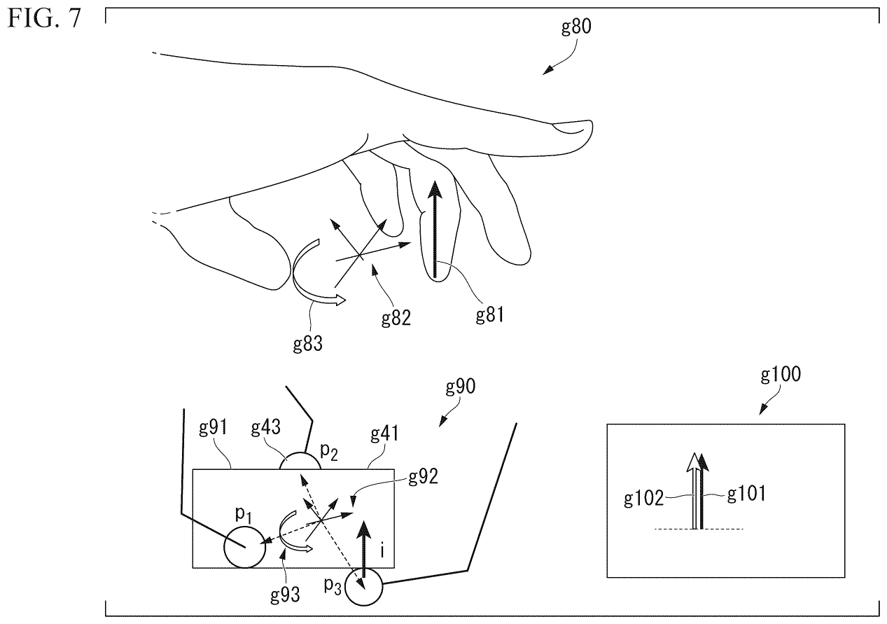

FIG. 7 is a diagram illustrating a second example of the process of generating a corrected instruction value.

An image g80 is an image of change of the fingers remotely controlled by the operator and change of the center coordinate. In the example of the image g80, an operation for shifting the ring finger upward and lifting an object as indicated by an arrow g81 is illustrated. Reference sign g82 indicates x, y, and z axes in the center coordinates. An arrow g83 indicates a rotating direction of the center coordinate when the fingertip is moved as indicated by the arrow g81.

An image g90 illustrates a contact relationship between an object and the fingers in an operating space of the robot and the center coordinate. Here, p1 is, for example, a fingertip position of a thumb, p2 is, for example, a fingertip position of an index finger, and p3 is, for example, a fingertip position of a ring finger. The image g90 is an image in which an object g91 which is a rectangular parallelepiped is lifted as indicated by an arrow i (shift) with sides surfaces of the object held with the thumb and the index finger and with the bottom surface supported with the ring finger. Reference sign g92 indicates x, y, and z axes in the center coordinates. An arrow g93 indicates a rotating direction of the center coordinate when the fingertip is moved as indicated by the arrow g81, and a shift of the fingertip of the robot based thereon for handling the object is indicated by an arrow i. In this case, since the shift i and the movement of the finger of the operator are close, the relative vector ii is almost zero.

An image g100 illustrates a normal component in the image g90. In the images g80 and g90, the normal component has infiltrated into the object, and a result (g102)≈i (which acts in the normal direction) of addition of a component (almost 0) of the relative vector ii with the normal component cancelled to the shift i (g101) of the coordinate conversion result based on change of the center coordinate by the arrow g81 is left.

[When Operator's Finger is Much Separated from Object]

The controller 27 may cause the robot to separate its finger when it is determined that a finger of the operator is much separated from an object and participate in handling the object again when the operator brings the finger into contact with the object again.

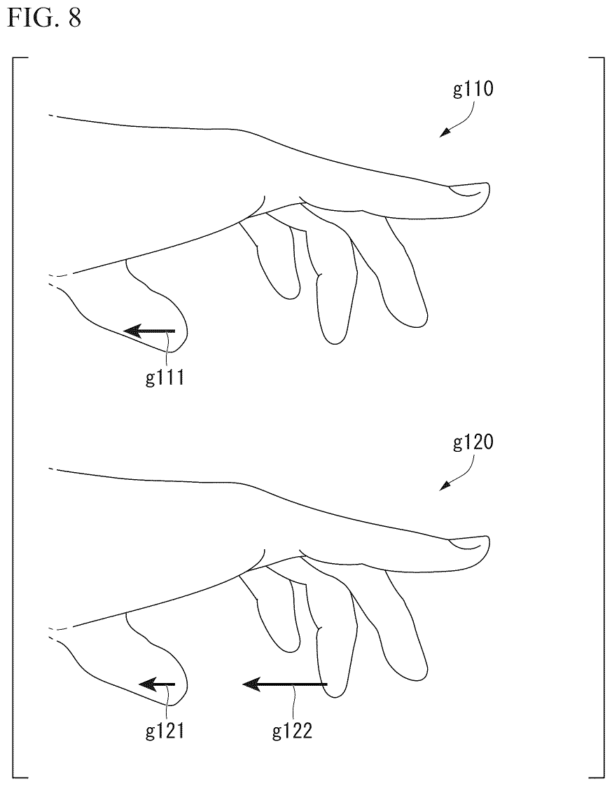

FIG. 8 is a diagram illustrating an operation when a finger of an operator is far away from an object.

An image g110 illustrates an example in which the operator attempts to remove a finger from an object. In this case, for example, the operator moves only the finger to be removed outward as indicated by an arrow g111.

An image g120 illustrates an example of a state in which the operator moves the object leftward with the object grasped using a thumb and an index finger. An arrow g122 indicates movement of a ring finger. For example, when it is attempted to move the object from right to left on the drawing, the operator applies a larger force to the ring finger than the thumb.

With a focus on only the thumb, as in the image g110 and the image g120, the force applied to the thumb seems to be the same when it is attempted to separate the thumb from the object and when it is attempted to move the object. Accordingly, with a focus on the thumb in the image g120, this movement may be determined to be an operation for separating the finger from the object.

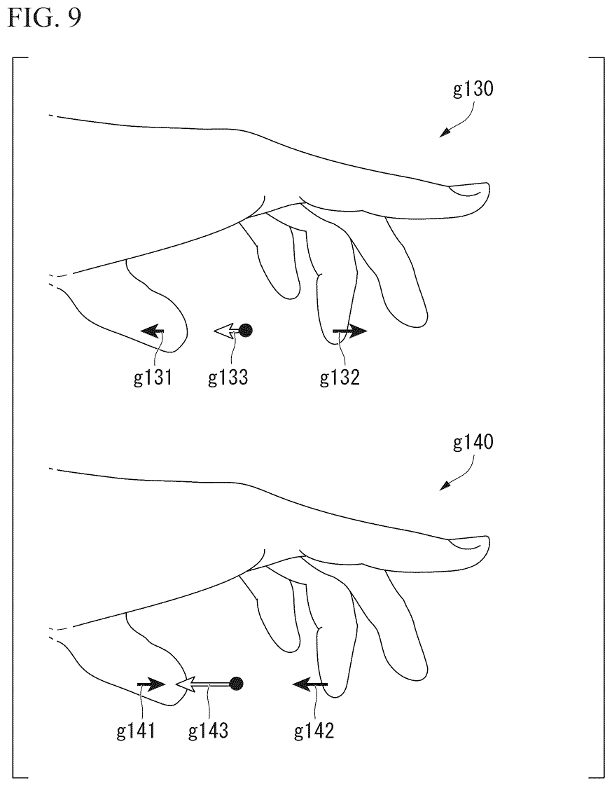

FIG. 9 is a diagram illustrating division of an operation for separating a finger and an operation for moving an object.

An image g130 illustrates a state in which fingers are separated from an object. Arrows g131 and g132 indicate relative vectors of the finger positions of the operator based on the fingertip positions pi subjected to coordinate conversion. An arrow g133 indicates movement of the center coordinate.

An image g140 illustrates a state in which an object is grasped and moved. Arrows g141 and g142 indicate relative vectors of the finger positions of the operator based on the fingertip positions pi subjected to coordinate conversion. An arrow g143 indicates movement of the center coordinate.

In this way, when it is determined that the operator attempts to separate the fingers from the object and the fingertip positions of the operator and the current fingertip positions of the robot are compared, it is difficult to handle this situation in view of a tracking delay. Accordingly, in the present embodiment, the operation for separating a finger and the operation for moving an object are divided by performing the determination on the basis of the operator's fingertip positions based on the fingertip positions pi subjected to coordinate conversion and the normal direction as illustrated in FIG. 9. For example, in the images g130 and g140, it is determined whether the operator's finger is located outside of the surface of the object or the operator's finger has infiltrated into the object on the basis of the relative vector and the normal direction for each finger.

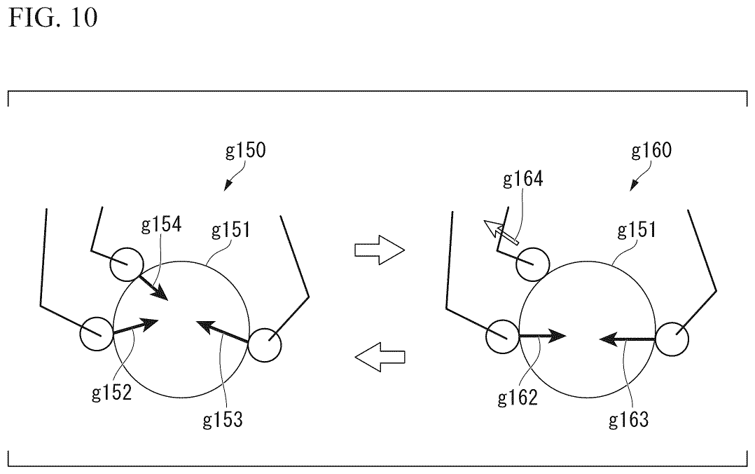

FIG. 10 is a diagram illustrating a control method when an object is grasped with three fingers and then one finger is separated from the object.

An image g150 illustrates an example in which an object g151 (for example, a sphere) is grasped with three fingers. Arrows g152 to g154 are forces acting on the object from the three fingers. In this case, the controller 27 calculates a balance between the forces on the basis of designated grasping strength (scalar value) and detection information from the tactile sensor 13 on the hand and controls the finger forces. In this case, three fingertip positions in contact are used to calculate the balance between the forces and to calculate the center coordinate.

An image g160 illustrates an example in which one finger is separated in a state in which an object g152 is grasped with two fingers. Arrows g162 and g162 are forces acting on the object from the two fingers. An arrow g164 indicates a direction and an amount of movement of a finger. In this case, the finger to be separated is excluded from calculation of the center coordinate and calculation of the balance between the forces, and two fingertip positions in contact are used.

In this case, in order not to attract the position of the center coordinate in the separating direction, the calculator 24 excludes the finger determined to be separated from calculation of the balance between the grasping forces and calculation of the center coordinate. Then, the calculator 24 performs coordinate conversion of the fingertip positions in the same (a component in the normal direction is not deleted for separation, and movement based on change of the center coordinates of the other fingers is performed to maintain the balance between forces) until contact between the object and the finger disappears.

When an instruction value has infiltrated into the object before the finger is separated, the controller 27 applies a force. The controller 27 sets a fingertip position piₛ when it is attempted to delete the component in the normal direction to be separated from the object separately from the fingertip position pi of the finger to be separated in order to determination infiltration into the object. The fingertip position piₛ is a reference point, is a virtual position, and a threshold position. The controller 27 skips the determination of a finger to be separated when the fingertip position pi is located inside of the fingertip position piₛ. This is because a reference point for determination of infiltration is separated from the surface of the object when the fingertip position pi of the finger to be separated is used without any change.

The fingertip position piₛ is, for example, a position which is separated by a predetermined distance from the fingertip position and is set, for example, near the surface position of the object. Accordingly, in the present embodiment, when a position of an instruction value for the fingertip of the operator is closer to the object than the fingertip position piₛ, it is determined that the finger comes into contact with the object again. In this way, the fingertip position piₛ is used to determine whether the operator attempts to stop separation before the finger is separated when the operator attempts to separate the end effector 10 from the object, and the fingertip position pi is used to generate the instruction value.

When two or more fingers do not apply a force, the center coordinate is calculated from a finger in contact, the same position correction is performed thereon, and a grasping force is not applied. In other words, for example, since the object cannot be grasped when the object is grasped with three fingers 11 and then two fingers 11 are separated from the object, the grasping force is not calculated and is not output to the end effector 10. Thereafter, the controller 27 continues to perform control while determining whether the other finger 11 is also separated from the object or whether an instruction to bring the separated fingers 11 into contact with the object again is given. In this way, even when only one finger 11 is in contact with the object, for example, a load center or the like is set as the center coordinate and the aforementioned control is performed.

### [Process Flow of Determining Finger Separation or the Like]

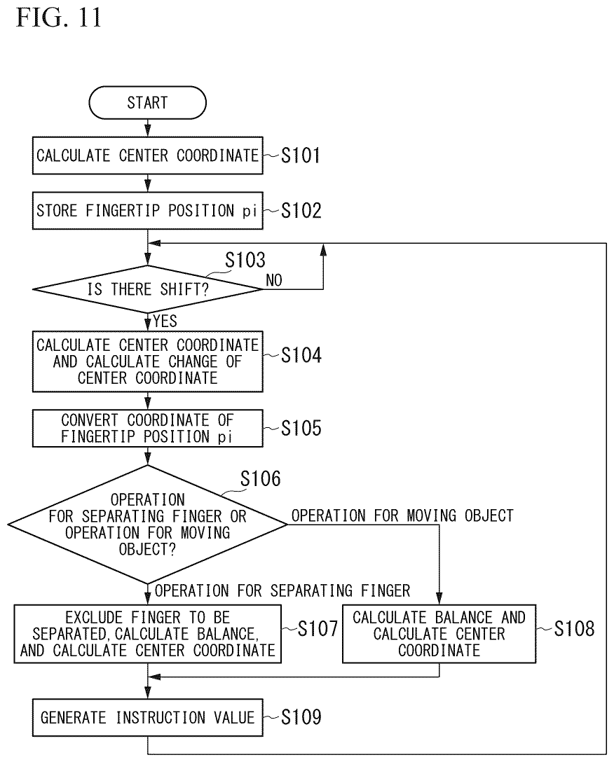

FIG. 11 is a flowchart illustrating a determination process of finger separation or the like according to the present embodiment. The following process flow is performed after a fingertip of the robot has come into contact with an object through remote control of the operator.
(Step S101) At the time of start of grasping (time t=1), the center coordinate calculator 241 calculates a center coordinate with the center coordinate of a contact point instruction value for the end effector 10 calculated from the action force information as an origin.
(Step S102) At the time of start of grasping, the contact point position calculator 242 calculates a contact point position pi of the end effector 10 with the object in the center coordinate system and stores a fingertip position pi of the robot in the coordinate system of the calculated center coordinate in the storage 26.
(Step S103) The controller 27 determines whether the fingertip position has shifted. When the fingertip position has shifted (Step S103: YES), the controller 27 causes the process flow to proceed to Step S104. When the fingertip position has not shifted (Step S103: NO), the controller 27 repeatedly performs the process of Step S103.
(Step S104) After the fingertip position has shifted (time t=2), the center coordinate calculator 241 calculates a center coordinate with the center coordinate of the contact point instruction value for the end effector 10 calculated from the action force information as an origin again. Subsequently, the center coordinate calculator 241 calculates a change of the center coordinate.
(Step S105) After the fingertip position has shifted (time t=2), the coordinate converter 243 converts the coordinate of the contact point position pi according to the calculated change of the coordinate on the basis of the action force information at the updating time.
(Step S106) The controller 27 determines whether this operation is an operation for separating a finger or an operation for moving the object on the basis of the finger position of the operator based on the fingertip position pi subjected to coordinate conversion with the change of the center coordinate and the normal direction. When this operation is an operation for separating a finger (Step S106: finger separating operation), the controller 27 causes the process flow to proceed to Step S107. When this operation is an operation for moving the object (Step S106: object moving operation), the controller 27 causes the process flow to proceed to Step S108.
(Step S107) The controller 27 excludes the finger determined to be separated from calculation of the balance between the grasping forces and calculation of the center coordinate. Subsequently, the calculator 24 calculates the balance between the grasping forces and calculates the center coordinate again. Thereafter, the controller 27 causes the process flow to proceed to Step S109.
(Step S108) The calculator 24 calculates the balance between the grasping forces and calculates the center coordinate again. Thereafter, the controller 27 causes the process flow to proceed to Step S109.
(Step S109) The controller 27 generates an instruction value on the basis of the calculation result of Step S107 or S108.

Through this process flow, it is possible to appropriately determine whether the operator attempts to separate a finger from the object or to move the object with the object grasped. Accordingly, according to the present embodiment, since the instruction values for the operation for separating a finger from the object and the operation for moving the object with the object grasped can be appropriately generated, it is possible to appropriately perform the operations.

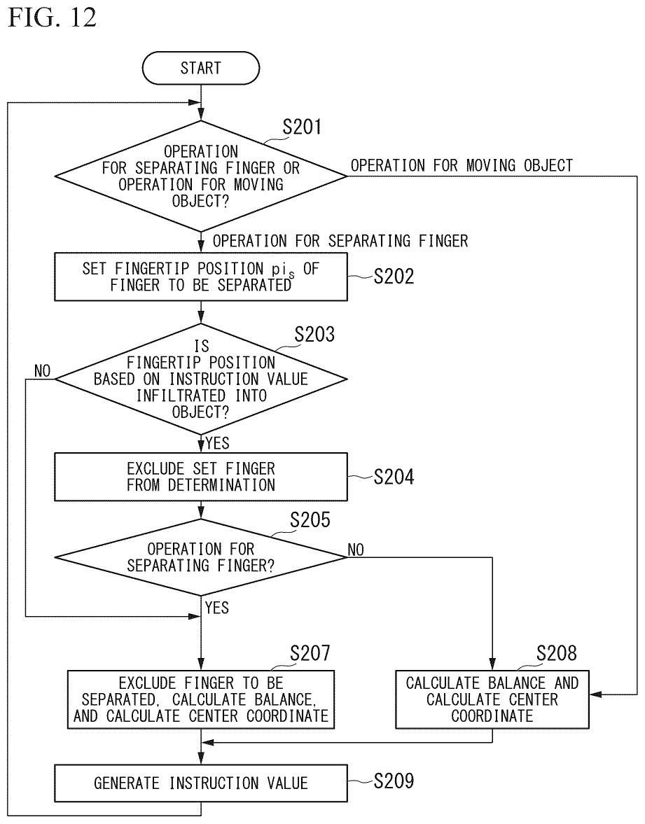

FIG. 12 is a flowchart illustrating a determination process of re-contact or the like according to the present embodiment. The following process flow is performed after a fingertip of the robot has come into contact with an object through remote control of the operator, a center coordinate has been calculated, and the fingertip position has been stored.
(Step S201) The controller 27 determines whether this operation is an operation for separating a finger or an operation for moving the object on the basis of the finger position of the operator based on the fingertip position pi subjected to coordinate conversion with the change of the center coordinate and the normal direction. When this operation is an operation for separating a finger (Step S201: finger separating operation), the controller 27 causes the process flow to proceed to Step S202. When this operation is an operation for moving the object (Step S201: object moving operation), the controller 27 causes the process flow to proceed to Step S208.
(Step S202) The contact point position calculator 242 sets a fingertip position piₛ of the finger to be separated from the object.
(Step S203) The controller 27 determines whether a fingertip position based on an instruction value has infiltrated into the object on the basis of a difference between the fingertip position pi and the fingertip position piₛ or a ratio of the fingertip position pi to the fingertip position piₛ. When it is determined that the fingertip position based on the instruction value has infiltrated into the object (Step S203: YES), the controller 27 causes the process flow to proceed to Step S204. When it is determined that the fingertip position based on the instruction value is not infiltrated into the object (Step S203: NO), the controller 27 causes the process flow to proceed to Step S207.
(Step S204) The controller 27 excludes the finger of which the fingertip position piₛ has been set in Step S202 from determination of whether the finger is separated from the object.
(Step S205) The controller 27 determines whether this operation is an operation for separating the finger from the object, for example, on the basis of a shift of the fingertip position. When this operation is an operation for separating the finger from the object (Step S205: YES), the controller 27 causes the process flow to proceed to Step S207. When this operation is not an operation for separating the finger from the object (Step S205: NO), the controller 27 causes the process flow to proceed to Step S208.
(Step S207) The controller 27 excludes the finger determined to be separated from calculation of the balance between the grasping forces and calculation of the center coordinate. Subsequently, the calculator 24 calculates the balance between the grasping forces and calculates the center coordinate again. Thereafter, the controller 27 causes the process flow to proceed to Step S209.
(Step S208) The calculator 24 calculates the balance between the grasping forces and calculates the center coordinate again. Thereafter, the controller 27 causes the process flow to proceed to Step S209.
(Step S209) The controller 27 generates an instruction value on the basis of the calculation result of Step S207 or S208. When the instruction value has infiltrated into the object before the finger is separated, the controller 27 performs control to apply a force to the object again.

Through this process flow, it is possible to appropriately determine whether the instruction value has infiltrated into the object before the finger is separated.

With the aforementioned process flow and configuration, according to the present embodiment, it is possible to support operating of an object without using object information and to expect improvement in a success rate thereof. According to the present embodiment, when a learning algorithm is used as an operator instead of a person, it is possible to perform the support and to expect improvement in learning efficiency.

In the aforementioned embodiment, process flow, and configuration, a data glove is exemplified as the operation input 3, but the present invention is not limited thereto. For example, a combination of an imaging device and a distance measuring device may be used as long as it is a sensor that can detect a position or a motion of a finger.

In the aforementioned embodiment, process flow, and configuration, an operator may perform remote control using both hands. In this case, the x-axis, y-axis, and z-axis directions in the center coordinates can be set, for example, with respect to one of fingers used for the remote control. The center coordinate in that case is a plurality of centers or centers of gravity or the like used for the remote control.

Some or all of the processes that are performed by the operation control device 2 may be realized by recording a program for realizing all or some of the functions of the operation control device 2 according to the present invention on a computer-readable recording medium and causing a computer system to read and execute the program recorded on the recording medium. The “computer system” mentioned herein may include an OS or hardware such as peripherals. The “computer system” may include a WWW system including a homepage provision environment (or display environment). The “computer-readable recording medium” may be a portable medium such as a flexible disk, a magneto-optical disc, a ROM, or a CD-ROM or a storage device such as a hard disk incorporated into a computer system. The “computer-readable recording medium” may include a medium that holds a program for a predetermined time such as a volatile memory (RAM) in a computer system serving as a server or a client when the program is transmitted via a network such as the Internet or a communication circuit line such as a telephone line.

Some or all of these constituents may be realized by hardware (a circuit unit including circuitry) such as an application-specific integrated circuit (ASIC), a field-programmable gate array (FPGA), a graphics processing unit (GPU), or a system on chip (SOC), or a large scale integration (LSI) circuit or may be cooperatively realized by software and hardware.

The program may be transmitted from a computer system in which the program is stored in a storage device or the like to another computer system via a transmission medium or carrier waves in the transmission medium. Here, the “transmission medium” for transmitting a program is a medium having a function of transmitting information such as a network (a communication network) such as the Internet or a communication circuit line (a communication line) such as a telephone line. The program may be a program for realizing some of the aforementioned functions. The program may be a so-called differential file (a differential program) that can realize the aforementioned functions in combination with another program stored in advance in the computer system.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An operation control method for an end effector including a plurality of contact portions which are able to handle an object, the operation control method comprising:
a step of transmitting action force information when an operator handles the object to the end effector;
a calculation step of calculating a target action force for grasping the object using the end effector from an acquired state of the operator and the acquired action force information;
a detection step of detecting a contact force at contact points at which the contact portions are in contact with the object; and
a control step of controlling an operation of a driver of the end effector such that an action force acting on the object from each contact element matches the target action force,
wherein the calculation step includes
setting a center coordinate system with a center coordinate of a contact point instruction value for the end effector calculated from the action force information as an origin,
calculating contact point positions of the end effector in the center coordinate system,
converting coordinates of the contact point positions according to a change of the center coordinate system calculated from the updated action force information, and
using an instruction value based on the coordinate-converted contact point positions as a corrected instruction value.

2. The operation control method according to claim 1, wherein the calculation step includes:
calculating a contact tangent component at each contact point of a difference between a shift of the action force information and a shift of the contact point positions due to the coordinate conversion; and
adding the contact tangent component to the coordinate-converted contact point positions to use the result as the corrected instruction value.

3. The operation control method according to claim 1, wherein the contact point positions are updated using the contact tangent component and the coordinates of the contact point positions are converted according to a change of the center coordinate system calculated from next updated action force information.

4. The operation control method according to claim 1, wherein the control step includes determining whether the operator is giving an instruction to separate the end effector including a plurality of fingers from the object after having brought the end effector into contact with the object or an instruction to move the object while grasping the object by determining whether a finger of the operator is located outside of a surface of the object or a finger of the operator has infiltrated into the object on the basis of a relative vector and a normal direction in the center coordinate system of each of the plurality of fingers.

5. The operation control method according to claim 1, wherein the control step includes
setting a temporary contact point position in a predetermined range from a surface of the object and
determining whether the operator is giving an instruction to separate the end effector away from the object after having been brought into contact with the object or whether the operator is attempting to separate the end effector away from the object and to stop separating of the end effector away from the object before the end effector is separated away from the object on the basis of the temporary contact point position and an instruction value given by the operator.

6. The operation control method according to claim 1, wherein the end effector includes a plurality of fingers, and
wherein the center coordinate system is set with one of the plurality of fingers as a reference, an axial direction passing through the center coordinate from the reference finger is set as a first axial direction, a second axial direction is set in a plane including the first axial direction, and a third axial direction is set with respect to the plane.

7. The operation control method according to claim 1, wherein the action force information is a joint angle of a finger of the operator, and
wherein the center coordinate system is a contact point instruction value for the end effector calculated in a state in which a joint angle of the end effector matches the joint angle of the operator.

8. An operation control device for an end effector including a plurality of contact portions which are able to handle an object, the operation control device comprising:
an output configured to transmit action force information when an operator handles the object to the end effector;
a calculator configured to calculate a target action force for grasping the object using the end effector from an acquired state of the operator and the acquired action force information;
a detector configured to detect a contact force at contact points at which the contact portions are in contact with the object; and
a controller configured to control an operation of a driver of the end effector such that an action force acting on the object from each contact element matches the target action force,
wherein the calculator performs
setting a center coordinate system with a center coordinate of a contact point instruction value for the end effector calculated from the action force information as an origin,
calculating contact point positions of the end effector in the center coordinate system,
converting coordinates of the contact point positions according to a change of the center coordinate system calculated from the updated action force information, and
using an instruction value based on the coordinate-converted contact point positions as a corrected instruction value.

9. A non-transitory computer-readable storage medium storing a program, the program causing a computer of an operation control device for an end effector including a plurality of contact portions which are able to handle an object to perform:
transmitting action force information when an operator handles the object to the end effector;
calculating a target action force for grasping the object using the end effector from an acquired state of the operator and the acquired action force information;
detecting a contact force at contact points at which the contact portions are in contact with the object; and
controlling an operation of a driver of the end effector such that an action force acting on the object from each contact element matches the target action force,
wherein the calculating of a target action force includes
setting a center coordinate system with a center coordinate of a contact point instruction value for the end effector calculated from the action force information as an origin,
calculating contact point positions of the end effector in the center coordinate system,
converting coordinates of the contact point positions according to a change of the center coordinate system calculated from the updated action force information, and
using an instruction value based on the coordinate-converted contact point positions as a corrected instruction value.
